(19) United States
(12) Patent Application Publication
(10) Pub. No.: US 2025/0045889 A1
(43) Pub. Date: Feb. 6, 2025

(54) INFORMATION PROCESSING DEVICE, INFORMATION PROCESSING METHOD, AND INFORMATION PROCESSING PROGRAM

(71) Applicant: FUJIFILM Corporation, Tokyo (JP)

(72) Inventor: Yuya NISHIO, Saitama-shi (JP)

(73) Assignee: FUJIFILM Corporation, Tokyo (JP)

(21) Appl. No.: 18/772,272

(22) Filed: Jul. 15, 2024

(30) Foreign Application Priority Data
Jul. 31, 2023 (JP) 2023-124105

(51) Int. Cl. G06T 5/92; G06T 5/50; G06T 5/70

(52) U.S. Cl. CPC G06T 5/92; G06T 5/50; G06T 5/70; G06T 2207/10016; G06T 2207/20021

(57) ABSTRACT

An information processing device performs processing on image data to be input. The information processing device includes: a processor configured to: acquire a first tone curve and a second tone curve; divide the image data into a plurality of blocks and determine a representative value for each block; generate a third tone curve for each block based on the first tone curve, the second tone curve, and the representative value; and determine a correction value to be applied to a target pixel based on the third tone curve of a target block including the target pixel and the third tone curve of a block different from the target block.

### CROSS-REFERENCE TO RELATED APPLICATIONS

This application is based on and claims priority under 35 USC 119 from Japanese Patent Application No. 2023-124105 filed on Jul. 31, 2023, the contents of which are incorporated herein by reference.

### BACKGROUND OF THE INVENTION

### 1. Field of the Invention

The present invention relates to an information processing device, an information processing method, and a computer-readable medium storing an information processing program.

### 2. Description of the Related Art

JP2014-126782A describes an image processing apparatus including: a weight calculation unit that sets a weight coefficient for making, with respect to a first gamma characteristic representing display characteristics in a case where there is no influence of external light on a display device to be connected, a second gamma characteristic, whose brightness range is narrower than that of the first gamma characteristic, closer to brightness of the first gamma characteristic as brightness information of a processing target image is darker, and that calculates a weight coefficient for making the second gamma characteristic closer to a gradient of the brightness of the first gamma characteristic as the brightness information is brighter; a gamma calculation unit that calculates a gamma conversion function based on the second gamma characteristic determined based on the weight coefficient; and a conversion unit that performs a conversion of a pixel value of the processing target image by using the gamma conversion function.

JP1998-210356A (JP-H10-210356A) describes a digital camera comprising: a block setting unit that sets a plurality of discrete blocks in an image captured by an imaging unit; a first y characteristic setting unit that sets a y characteristic with respect to a pixel signal of a center position of a block by using pixel signals included in the block; a second y characteristic setting unit that sets a y characteristic with respect to a pixel signal other than the center position of each block by using the y characteristic set by the first y characteristic setting unit; and a gamma correction unit that performs gamma correction of a corresponding pixel signal by using the y characteristics set by the first y characteristic setting unit and the second y characteristic setting unit.

### SUMMARY OF THE INVENTION

One embodiment according to the technology of the present disclosure provides an information processing device, an information processing method, and a computer-readable medium storing an information processing program capable of improving image quality.

(1)

An information processing device that performs processing on image data to be input, the information processing device comprising:
a processor configured to:
   acquire a first tone curve and a second tone curve;
   divide the image data into a plurality of blocks and determine a representative value for each block;
   generate a third tone curve for each block based on the first tone curve, the second tone curve, and the representative value; and
   determine a correction value to be applied to a target pixel based on the third tone curve of a target block including the target pixel and the third tone curve of a block different from the target block.
      (2)

The information processing device according to (1),
in which the processor is configured to generate the third tone curve by mixing the first tone curve and the second tone curve at a mixing ratio based on the representative value.
   (3)

The information processing device according to (2),
in which the processor is configured to determine the mixing ratio corresponding to the representative value based on a mode of the processing.
   (4)

The information processing device according to any one of (1) to (3),
in which an average value of output values of the first tone curve is higher than an average value of output values of the second tone curve.
   (5)

The information processing device according to (4),
in which the output values of the first tone curve are equal to or greater than the output values of the second tone curve for all input values.
   (6)

The information processing device according to any one of (1) to (5),
in which the processor is configured to acquire the first tone curve and the second tone curve corresponding to a mode of the processing.
   (7)

The information processing device according to any one of (1) to (6),
in which the processor is configured to, in a case where the image data is moving image data, generate the third tone curve of a target frame of the moving image data based on the third tone curve of a frame preceding the target frame.
   (8)

The information processing device according to any one of (1) to (7),
in which the processor is configured to determine the number of divisions of the block according to a type of the image data to be input.
   (9)

The information processing device according to any one of (1) to (8),
in which the processor is configured to correct the third tone curve of the target block by weighted averaging with the third tone curve of the block different from the target block.
   (10)

The information processing device according to any one of (1) to (9),
in which the processor is configured to, in a case where the image data is moving image data:
   generate the third tone curve for a periodic first target frame group in the moving image data; and
   determine, based on the third tone curve generated for the first target frame group, the correction value for a second target frame group different from the first target frame group in the moving image data.
      (11)

The information processing device according to (10),
in which the processor is configured to set the first target frame group according to attribute information of the moving image data.
   (12)

The information processing device according to any one of (1) to (11),
in which the processor is configured to determine, based on the determined correction value of each pixel, a noise reduction intensity with respect to each pixel of the image data that has been subjected to a correction process using the correction value.
   (13)

The information processing device according to any one of (1) to (12),
in which the processor is configured to:
   generate correspondence information between a pixel value and a noise reduction intensity for each block based on the representative value; and
   determine a noise reduction intensity to be applied to the target pixel based on the correspondence information of the target block including the target pixel and the correspondence information of the block different from the target block.
      (14)

The information processing device according to any one of (1) to (13),
in which the processor is configured to determine at least any of the number of divisions of the block or a division shape of the block based on a result of subject detection of the image data.
   (15)

The information processing device according to any one of (1) to (14),
in which the processor is configured to determine, based on a result of subject detection of the image data, the correction value based on the third tone curve of the target block and the third tone curve of the block different from the target block.
   (16)

An information processing method executed by an information processing device that includes a processor and performs processing on image data to be input, the information processing method causing the processor to execute:
acquiring a first tone curve and a second tone curve;
dividing the image data into a plurality of blocks and determining a representative value for each block;
generating a third tone curve for each block based on the first tone curve, the second tone curve, and the representative value; and
determining a correction value to be applied to a target pixel based on the third tone curve of a target block including the target pixel and the third tone curve of a block different from the target block.
   (17)

A non-transitory computer-readable medium storing an information processing program for an information processing device that includes a processor and performs processing on image data to be input, the information processing program causing the processor to execute a process comprising:
acquiring a first tone curve and a second tone curve;
dividing the image data into a plurality of blocks and determining a representative value for each block;
generating a third tone curve for each block based on the first tone curve, the second tone curve, and the representative value; and
determining a correction value to be applied to a target pixel based on the third tone curve of a target block including the target pixel and the third tone curve of a block different from the target block.

According to the present invention, it is possible to provide an information processing device, an information processing method, and an information processing program capable of improving image quality.

### BRIEF DESCRIPTION OF THE DRAWINGS

FIG. 1 is a diagram showing an example of an imaging apparatus equipped with an information processing device of the present embodiment.

FIG. 2 is a block diagram of an image processing unit 122 provided in the information processing device of the present embodiment.

FIG. 3 is a flowchart showing an example of processing by the image processing unit 122 of the information processing device.

FIG. 4 is a diagram showing an example of a bright portion tone curve 31 and a dark portion tone curve 32.

FIG. 5 is a diagram showing an example of a block 42 for dividing a brightness image 41.

FIG. 6 is a diagram showing an example of a representative brightness value for each block 42.

FIG. 7 is a diagram showing an example of correspondence information 51 between the representative brightness value and a tone curve mixing rate.

FIG. 8 is a diagram showing an example of generation of the correspondence information 51 shown in FIG. 7.

FIG. 9 is a diagram showing an example of generation of a mixed tone curve 34.

FIG. 10 is a diagram showing a modification example of the generation of the mixed tone curve 34.

FIG. 11 is a diagram showing an example of the mixed tone curve 34 generated for each block.

FIG. 12 is a diagram showing an example of calculation of a gain of each pixel in each block 42.

FIG. 13 is a diagram showing an example of a representative brightness value for each block of a plurality of frames in moving image data.

FIG. 14 is a diagram showing an example of a block 42 for dividing a still image.

FIG. 15 is a diagram showing an example of a block 42 for dividing a video.

FIG. 16 is a diagram showing an example of correction of the mixed tone curve 34.

FIG. 17 is a diagram showing an example (first generation example) of generation of the mixed tone curve 34 in a case where the image data is the moving image data.

FIG. 18 is a diagram showing an example (second generation example) of generation of the mixed tone curve 34 in a case where the image data is the moving image data.

FIG. 19 is a diagram showing an example of correspondence information between an input brightness and a noise reduction intensity.

FIG. 20 is a diagram showing an example of a noise reduction intensity determined for each block 42.

FIG. 21 is a diagram showing an example of calculation of the noise reduction intensity of each pixel.

FIG. 22 is a diagram showing an example of image division in a case where a subject is large.

FIG. 23 is a diagram showing an example of image division in a case where the subject is small.

FIG. 24 is a diagram showing an example of image division for each type of the subject.

FIG. 25 is a diagram showing an example of weighting with a peripheral block in a case where the detected subject is large.

FIG. 26 is a diagram showing an example of the subject for which weighting with the peripheral block is not performed.

### DESCRIPTION OF THE PREFERRED EMBODIMENTS

Hereinafter, an example of an embodiment of the present invention will be described with reference to the drawings.

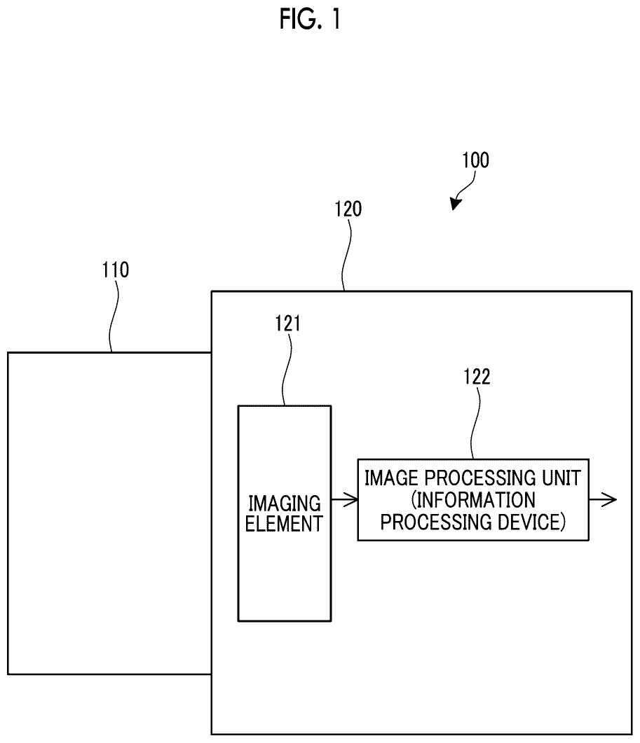

Imaging Apparatus Equipped with Information Processing Device of Embodiment FIG. 1 is a diagram showing an example of an imaging apparatus equipped with an information processing device of the present embodiment. As shown in FIG. 1, examples of an imaging apparatus 100 include a single-lens reflex camera and a digital camera. The imaging apparatus 100 comprises a main body 120 and a lens device 110 attached to the main body 120. The main body 120 is equipped with an imaging element 121 and an image processing unit 122. The image processing unit 122 is an example of a “processor” in the present invention. The image processing unit 122 is an image processing unit provided in the information processing device of the present embodiment.

The lens device 110 is a device that collects light to create an image. The lens device 110 may be an interchangeable lens device with respect to the main body 120 or may be a fixed lens device.

The imaging element 121 is a semiconductor sensor that converts the light captured from the lens device 110 into digital data. The semiconductor sensor includes, for example, a charge coupled device (CCD) sensor, a complementary metal oxide semiconductor (CMOS) sensor, or the like. The imaging element 121 outputs the digitized image to the image processing unit 122 of the information processing device.

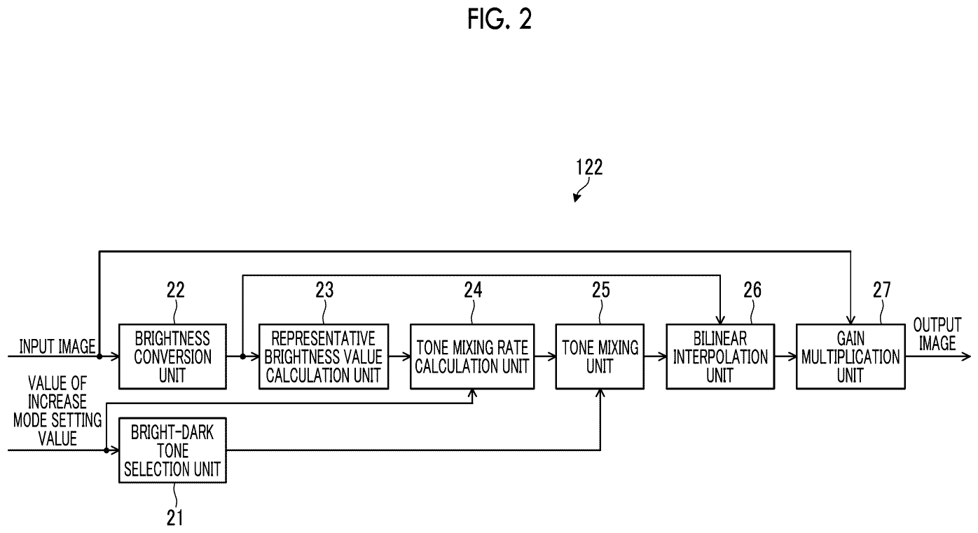

The image processing unit 122 performs processing on the image input from the imaging element 121 and outputs the image as a processed image. The processing by the image processing unit 122 includes, for example, local tone curve mapping (LTM). The processing content by the image processing unit 122 will be described in detail with reference to FIG. 2 and subsequent drawings.

The image output from the image processing unit 122 is stored in a storage medium (not shown). In addition, the image output from the image processing unit 122 is displayed on, for example, a display provided on a rear surface of the main body 120. The image displayed on the display may be displayed as, for example, a still image or may be displayed as a live view image.

### Configuration of Image Processing Unit 122 of Information Processing Device

FIG. 2 is a block diagram of the image processing unit 122 provided in the information processing device of the present embodiment. The image processing unit 122 comprises a bright-dark tone curve selection unit 21, a brightness conversion unit 22, a representative brightness value calculation unit 23, a tone curve mixing rate calculation unit 24, a tone curve mixing unit 25, a bilinear interpolation unit 26, and a gain multiplication unit 27.

The bright-dark tone curve selection unit 21 selects a bright portion tone curve for adjusting the brightness or the contrast of a bright portion of the image and a dark portion tone curve for adjusting the brightness or the contrast of a dark portion thereof based on an amount of increase in exposure during the imaging of the imaging apparatus 100 and a mode setting value of the imaging apparatus 100. The amount of increase in exposure is an amount of dynamic range expansion and is a difference between an exposure value set during the imaging and an actual exposure value during the imaging. The exposure value set during the imaging is a value set by a user in a case of manual, and is an automatically set value or a value obtained by adding a user setting (+1, ±0, −1, or the like) to the automatic setting in a case of automatic exposure (AE). The actual exposure value during the imaging is set to be lower (darker) than the exposure value set during the imaging, in consideration of the increase in the subsequent gradation processing. In addition, the mode is a mode in which processing is performed on the input image, and relates to, for example, a setting value (for example, a name of a taste) of gradation processing of the image (a color profile function of making drawing such as tint have a specific taste). The mode can be set manually or automatically.

The bright portion tone curve and the dark portion tone curve are prepared in advance for each combination of the amount of increase in exposure and the mode of the gradation processing. Specifically, for each type (mode) of the gradation processing, a plurality of patterns of tone curves having different amounts of increase in the brightness while having the same taste of the gradation are prepared. The dark portion tone curve is an example of a “first tone curve” in the present invention. The bright portion tone curve is an example of a “second tone curve” in the present invention. The bright-dark tone curve selection unit 21 outputs the selected bright portion tone curve and dark portion tone curve to the tone curve mixing unit 25. The tone curve may be a look-up table-indicating a correspondence between the input and the output or may be a gain look-up table indicating a correspondence relationship between the input and the gain.

The brightness conversion unit 22 converts the input image (RGB image) from the imaging element 121 into a brightness image. The brightness image may be represented by Y of YCbCr (YPbPr) or YUV, or may be represented by a value obtained by mixing Y and the maximum value of RGB. The brightness conversion unit 22 outputs the converted brightness image to the representative brightness value calculation unit 23 and the bilinear interpolation unit 26.

The representative brightness value calculation unit 23 calculates a representative value of the brightness in the brightness image. The representative brightness value calculation unit 23 divides the brightness image into, for example, grid-like blocks of 6 vertically×8 horizontally. The division into blocks is to group each pixel of the brightness image. The representative brightness value calculation unit 23 calculates a representative brightness value for each divided block. The representative brightness value for each block is a representative value of the brightness of the pixels in the block, and is, for example, a brightness value representing a feature of the entire block data, such as an average brightness value, a median brightness value, and a mode brightness value of the pixels in the block. The representative brightness value calculation unit 23 outputs the calculated representative brightness value of each block to the tone curve mixing rate calculation unit 24.

The tone curve mixing rate calculation unit 24 calculates a tone curve mixing rate between the bright portion tone curve and the dark portion tone curve for each block based on the representative brightness value of each block. In a case where the tone curve mixing rate is calculated based on the representative brightness value, correspondence information (for example, refer to FIG. 7) representing a correspondence relationship between the representative brightness value and the tone curve mixing rate is prepared in advance for each combination of the mode of the gradation processing of the image and the amount of increase in exposure. The tone curve mixing rate calculation unit 24 selects predetermined correspondence information based on the mode of the gradation processing and the amount of increase and calculates the tone curve mixing rate with respect to the representative brightness value. The tone curve mixing rate calculation unit 24 outputs the calculated tone curve mixing rate of each block to the tone curve mixing unit 25.

The tone curve mixing unit 25 generates a mixed tone curve of each block based on the bright portion tone curve and the dark portion tone curve selected by the bright-dark tone curve selection unit 21 and the tone curve mixing rate for each block calculated by the tone curve mixing rate calculation unit 24. The mixed tone curve is an example of a “third tone curve” in the present invention. The tone curve mixing unit 25 outputs the generated mixed tone curve of each block to the bilinear interpolation unit 26.

The bilinear interpolation unit 26 determines, for each pixel of the input image, a gain value (output brightness/input brightness) to be applied to a target pixel based on the mixed tone curve of a target block including the target pixel and the mixed tone curve of a block different from the target block. The block different from the target block is a peripheral block (for example, an adjacent block) of the target block. The bilinear interpolation unit 26 calculates a gain value of a predetermined pixel (for example, a pixel of a center point) from, for example, the mixed tone curve of the peripheral block and calculates a gain value of the target pixel through bilinear interpolation between the gain values. The gain value is an example of a “correction value” in the present invention. The bilinear interpolation unit 26 outputs the calculated gain value of each pixel to the gain multiplication unit 27.

The gain multiplication unit 27 calculates each pixel (RIG/B) of an output image by multiplying each pixel (R/G/B) in the input image by the gain value of each pixel calculated by the bilinear interpolation unit 26. The gain multiplication unit 27 generates the output image based on each pixel (R/G/B) calculated and outputs the generated output image.

### Processing by Image Processing Unit 122 of Information Processing Device

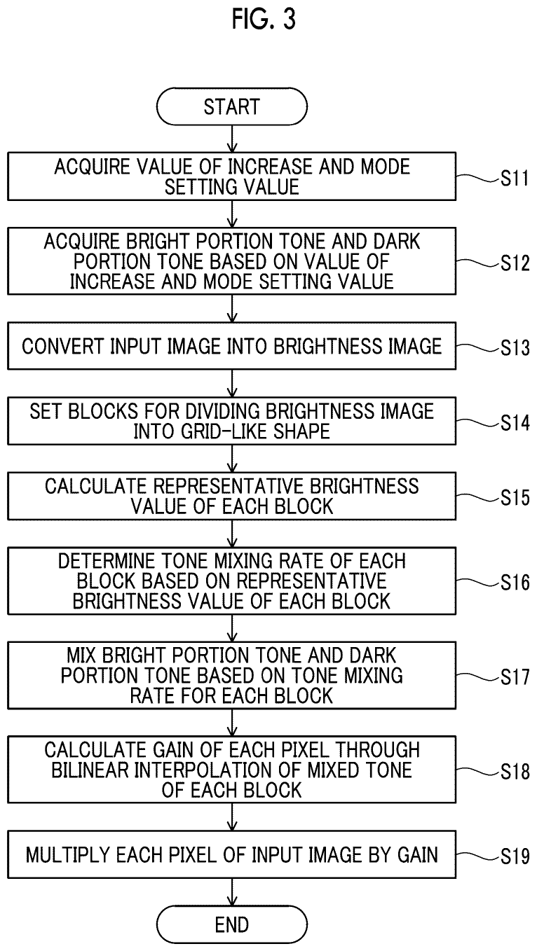

FIG. 3 is a flowchart showing an example of processing by the image processing unit 122 of the information processing device. The image processing unit 122 starts this processing during the imaging of the imaging apparatus 100.

First, the image processing unit 122 acquires the amount of increase in exposure during the imaging of the imaging apparatus 100 and the mode setting value of the imaging apparatus 100 (step S11).

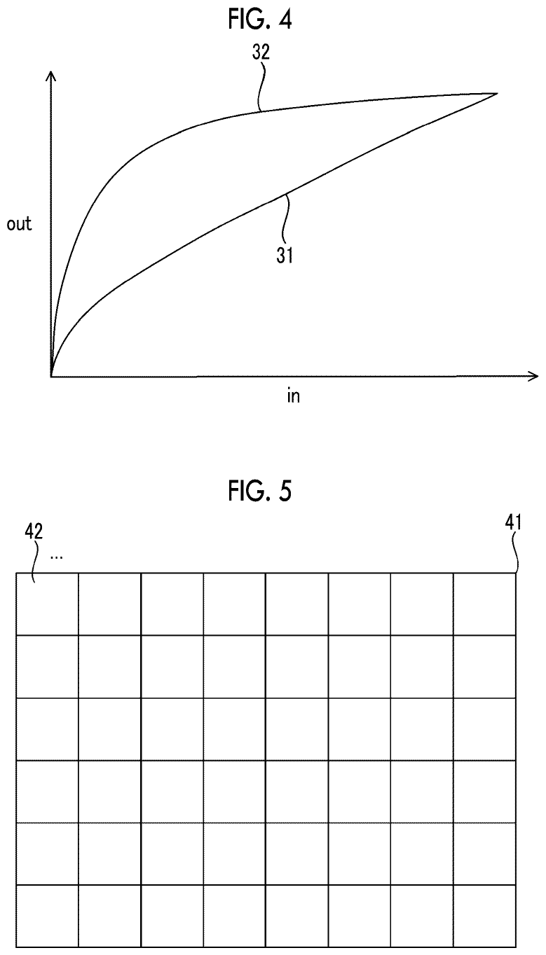

Next, the image processing unit 122 acquires the bright portion tone curve and the dark portion tone curve based on the amount of increase and the mode setting value acquired in step S11 (step S12). The bright portion tone curve and the dark portion tone curve are prepared in advance according to combinations of the amounts of increase in exposure and the modes of the gradation processing as described above. For example, the bright portion tone curve and the dark portion tone curve are prepared for a plurality of discrete amounts of increase (for example, +3, +2, +1, and 0) for each mode of the gradation processing. In this case, the bright portion tone curve and the dark portion tone curve corresponding to the amount of increase (for example, +2.7) other than the above-described plurality of discrete amounts of increase are derived through interpolation from the bright portion tone curve and the dark portion tone curve corresponding to the discrete amounts of increase before and after. The bright portion tone curve and the dark portion tone curve will be described below with reference to FIG. 4.

Next, the image processing unit 122 converts the input image (RGB image) from the imaging element 121 into the brightness image (step S13).

Next, the image processing unit 122 sets a plurality of blocks for dividing the brightness image converted in step S13, for example, into a grid-like shape (step S14). The setting of the block will be described below with reference to FIG. 5.

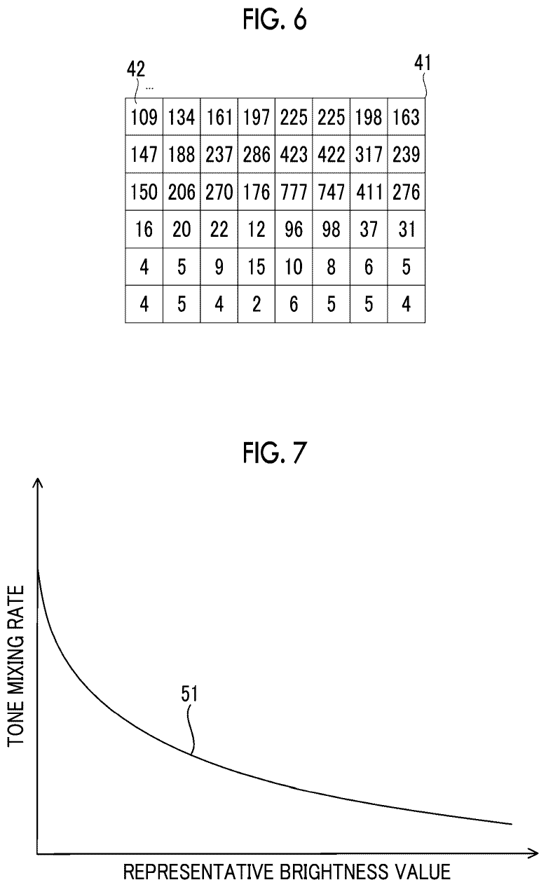

Next, the image processing unit 122 calculates the representative brightness value for each block set in step S14 (step S15). The representative brightness value for each block will be described below with reference to FIG. 6.

Next, the image processing unit 122 determines the tone curve mixing rate for each block for the bright portion tone curve and the dark portion tone curve acquired in step S12 based on the representative brightness value of each block calculated in step S15 (step S16). As described above, the correspondence information between the representative brightness value and the tone curve mixing rate is prepared in advance for each combination of the mode of the gradation processing of the image and the amount of increase in exposure. The image processing unit 122 determines the tone curve mixing rate with respect to the representative brightness value for each block based on the correspondence information corresponding to the mode of the gradation processing and the amount of increase. The determination of the tone curve mixing rate with respect to the representative brightness value will be described below with reference to FIG. 7.

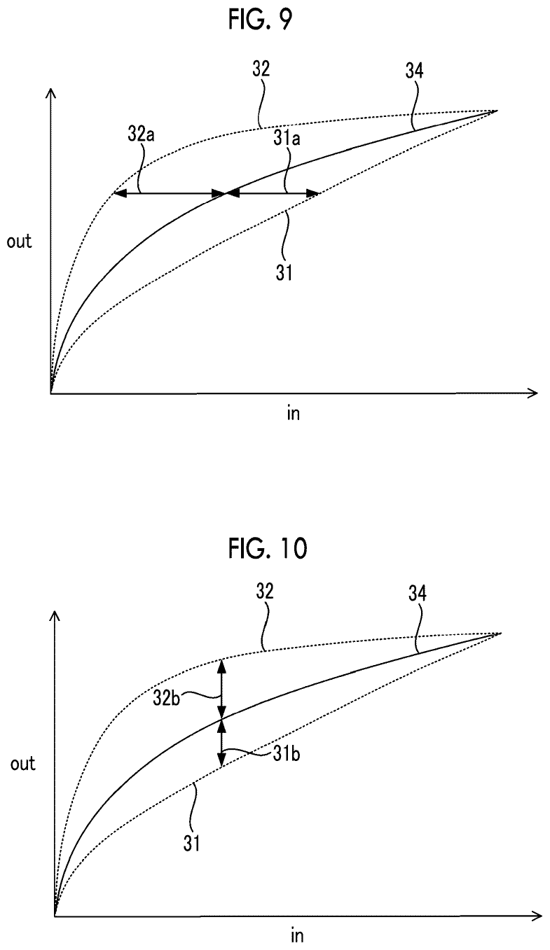

Next, the image processing unit 122 mixes the bright portion tone curve and the dark portion tone curve for each block based on the tone curve mixing rate of each block determined in step S16 to generate a mixed tone curve (step S17). The generation of the mixed tone curve of each block will be described below with reference to FIGS. 9 to 11.

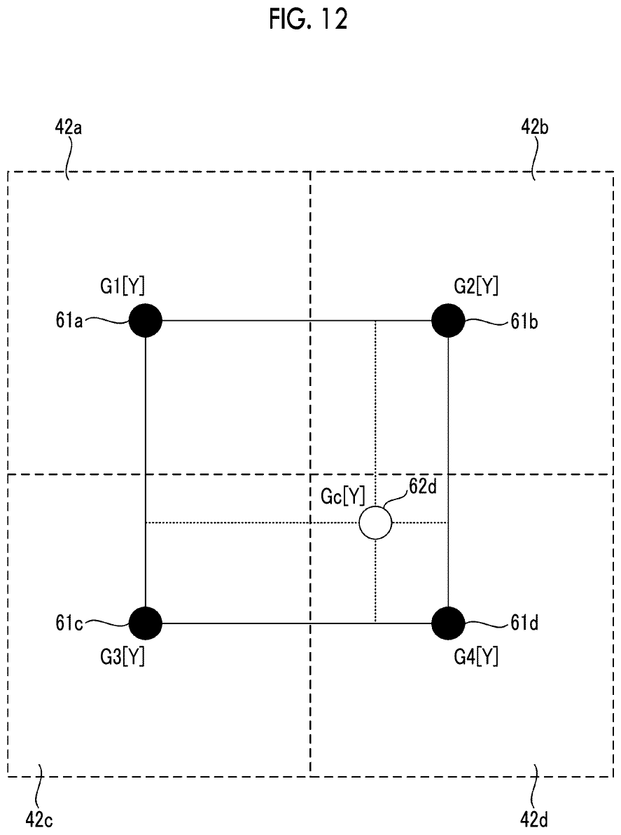

Next, the image processing unit 122 calculates a gain (output brightness/input brightness) to be applied to each pixel of the input image by performing bilinear interpolation based on the mixed tone curve of each block generated in step S17 (step S18). The gain of each pixel is calculated based on the mixed tone curve of the target block including the target pixel and the mixed tone curve of the block adjacent to the target block, as described above. The bilinear interpolation of the mixed tone curve will be described below with reference to FIG. 12.

Next, the image processing unit 122 calculates each pixel (RIG/B) of the output image by multiplying each pixel (R/G/B) of the input image by the gain calculated in step S18 (step S19).

### Bright Portion Tone Curve and Dark Portion Tone Curve

FIG. 4 is a diagram showing an example of a bright portion tone curve 31 and a dark portion tone curve 32. The bright portion tone curve 31 and the dark portion tone curve 32 are examples of the bright portion tone curve and the dark portion tone curve acquired in step S12 of FIG. 3. The bright portion tone curve 31 and the dark portion tone curve 32 are prepared in a plurality of aspects corresponding to combinations of the amounts of increase in exposure and the modes of the gradation processing. The average value of output values of the dark portion tone curve 32 is higher than the average value of output values of the bright portion tone curve 31. For example, the output values of the dark portion tone curve 32 are equal to or greater than the output values of the bright portion tone curve 31 for all input values.

### Block for Dividing Brightness Image

FIG. 5 is a diagram showing an example of the block 42 for dividing the brightness image 41. The block 42 is a block set in step S14 of FIG. 3. In the example shown in FIG. 5, the block 42 for dividing the brightness image 41 into a grid-like shape of 6 vertically×8 horizontally is shown. The number of blocks to be divided may be changed according to, for example, the type of the subject in the image data (input image). For example, the number of blocks to be divided may be changed depending on whether the subject is a still image or a moving image. In addition, the number of blocks to be divided may be changed depending on whether the subject is a person or a landscape. Further, the number of blocks to be divided may be changed according to the size of the subject.

### Representative Brightness Value of Each Block

FIG. 6 is a diagram showing an example of a representative brightness value for each block 42. The representative brightness value is an example of the brightness value of each block 42 calculated in step S15 of FIG. 3. In a case of the present example, the average brightness value of the pixels in each block 42 is displayed as the representative brightness value in 48 blocks 42 divided into a grid-like shape of 6 vertically×8 horizontally. The representative brightness value may be a median brightness value, a mode brightness value, or the like as described above.

### Correspondence Information Between Representative Brightness Value and Tone Curve Mixing Rate

FIG. 7 is a diagram showing an example of the correspondence information 51 between the representative brightness value and the tone curve mixing rate. The tone curve mixing rate is an example of the tone curve mixing rate determined in step S16 of FIG. 3. The correspondence information 51 is prepared in a plurality of aspects corresponding to the combinations of the modes of the gradation processing of the image and the amounts of increase in exposure. The predetermined correspondence information 51 is selected according to the set mode of the gradation processing and the amount of increase, and the tone curve mixing rate with respect to the representative brightness value is determined for each block 42 based on the selected correspondence information 51.

### Generation of Correspondence Information

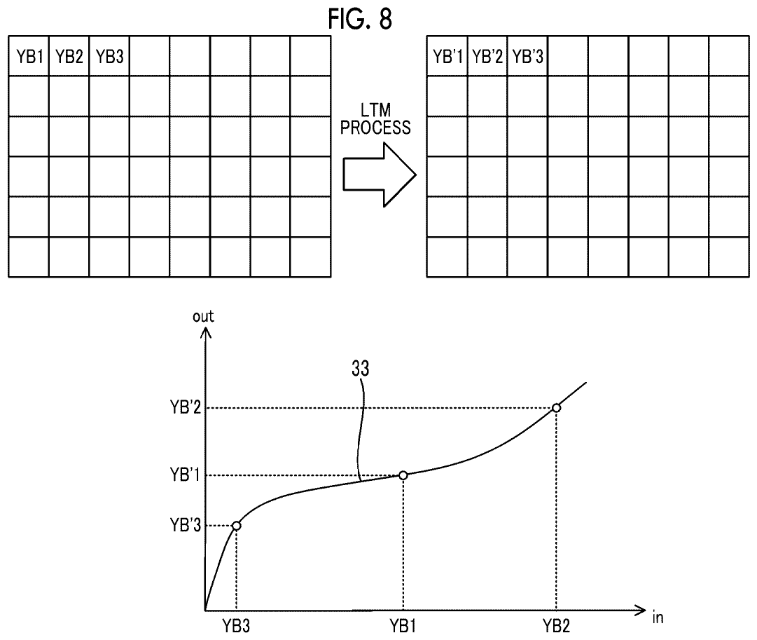

FIG. 8 is a diagram showing an example of the generation of the correspondence information 51 shown in FIG. 7. The image processing unit 122 generates the correspondence information 51 prepared for each combination of the mode of the gradation processing of the image and the amount of increase in exposure, for example, as follows.

In generating the correspondence information 51, for example, a reference tone curve 33 as shown in FIG. 8 is defined for each combination of the mode of the gradation processing of the image and the amount of increase in exposure. The reference tone curve 33 is information indicating a correspondence relationship between the input and the output of the representative brightness for each block.

The image processing unit 122 calculates the tone curve mixing rate for each representative brightness value such that a relationship between the representative brightness value before the correction of the pixel value by a local tone curve mapping process and the representative brightness value after the correction of the pixel value by the LTM process (the representative brightness value obtained in a case where the same processing as the calculation of the brightness value and the calculation of the representative brightness value for each block, which have been performed for the input image, is performed for the output image after the correction) approaches the reference tone curve 33, for each combination of the mode of the gradation processing of the image and the amount of increase in exposure. Specifically, as shown in FIG. 8, the image processing unit 122 calculates the tone curve mixing rate such that the relationship between representative brightness values YB1, YB2, and YB3 (input values) of the respective blocks and representative brightness values YB′1, YB′2, and YB′3 (output values) obtained by multiplying the representative brightness values YB1, YB2, and YB3 by the tone curves of the respective blocks approaches the reference tone curve 33.

As a result, the correspondence information 51 is generated for each combination of the mode of the gradation processing of the image and the amount of increase in exposure. The correspondence information 51 may be generated in advance based on the reference tone curve 33, or the image processing unit 122 may calculate the correspondence information 51 based on the reference tone curve 33 each time.

### Generation of Mixed Tone Curve

FIG. 9 is a diagram showing an example of the generation of the mixed tone curve 34. The mixed tone curve 34 is an example of the mixed tone curve generated in step S17 of FIG. 3. The mixed tone curve 34 is generated for each block 42 based on the bright portion tone curve and the dark portion tone curve, and the tone curve mixing rate thereof, as described above.

In this case, the image processing unit 122 selects a predetermined bright portion tone curve 31 and a predetermined dark portion tone curve 32, from among a plurality of bright portion tone curves and dark portion tone curves prepared in advance, based on the mode of the gradation processing of the image and the amount of increase in exposure.

In addition, the image processing unit 122 selects predetermined correspondence information 51, from among a plurality of pieces of correspondence information prepared in advance, based on the mode of the gradation processing of the image and the amount of increase in exposure, and determines the tone curve mixing rate of the bright portion tone curve and the dark portion tone curve with respect to the representative brightness value of each block 42 based on the selected correspondence information 51. In this case, for example, in a case where the mixing rate of the dark portion tone curve 32 is represented by a dark portion tone curve mixing rate a, the mixing rate of the bright portion tone curve 31 can be represented by a bright portion tone curve mixing rate 1−α.

Then, the image processing unit 122 generates, based on the selected bright portion tone curve 31 and dark portion tone curve 32 and the determined tone curve mixing rate of each block 42, the mixed tone curve 34 such that a ratio between an input value difference 32a between each output value (vertical axis value) and the dark portion tone curve 32, and an input value difference 31a between each output value (vertical axis value) and the bright portion tone curve 31 is the input value difference 32a:the input value difference 31a=1−α:α, as shown in FIG. 9. The image processing unit 122 generates the mixed tone curve 34 for each block 42.

FIG. 10 is a diagram showing a modification example of the generation of the mixed tone curve 34. In the generation example shown in FIG. 9, a case has been described in which the mixed tone curve 34 is generated such that the input value difference 32a between each output value and the dark portion tone curve 32: the input value difference 31a between each output value and the bright portion tone curve 31=1−α:α, but in the present modification example, the image processing unit 122 generates the mixed tone curve such that a ratio between the output value differences between each input value and each tone curve is a predetermined tone curve mixing rate.

Specifically, the image processing unit 122 selects a predetermined bright portion tone curve 31 and a predetermined dark portion tone curve 32, and predetermined correspondence information based on the mode of the gradation processing of the image and the amount of increase in exposure, and determines the tone curve mixing rate of each block 42 (the dark portion tone curve mixing rate a and the bright portion tone curve mixing rate 1−α). These generation processes are the same as the generation example shown in FIG. 9.

Next, in a case of the present modification example, the mixed tone curve 34 is generated based on the selected bright portion tone curve 31 and dark portion tone curve 32 and the determined tone curve mixing rate of each block 42 such that a ratio between an output value difference 32b between each input value (horizontal axis value) and the dark portion tone curve 32, and an output value difference 31b between each input value (horizontal axis value) and the bright portion tone curve 31 is the output value difference 32b:the output value difference 31b=1−α:α, as shown in FIG. 10. The mixed tone curve 34 is generated for each block 42.

### Mixed Tone Curve for Each Block

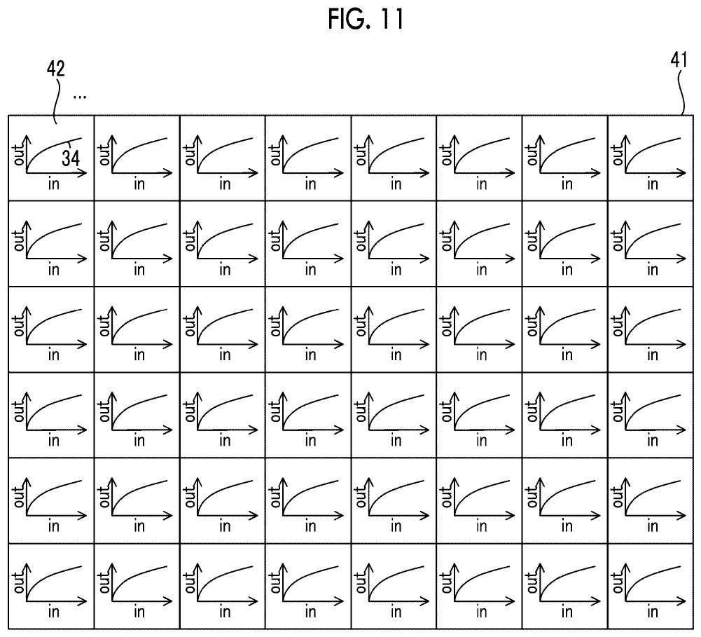

FIG. 11 is a diagram showing an example of the mixed tone curve 34 generated for each block. As shown in FIG. 11, the mixed tone curve 34 is generated for each block 42 divided into a grid-like shape of 6 vertically×8 horizontally. In FIG. 11, the same mixed tone curve 34 is shown for each block 42, but in reality, the mixed tone curve 34 having a shape corresponding to the representative brightness value of each block is used.

Calculation of Gain Value of Each Pixel FIG. 12 is a diagram showing an example of the calculation of the gain value of each pixel in each block 42. For example, a case is considered in which a gain value of a target pixel 62d on a block 42d is calculated in blocks 42a, 42b, 42c, and 42d of the brightness image 41 divided as shown in FIG. 12.

In this case, a pixel disposed at the center of the block 42d including the target pixel 62d is set as a center pixel 61d. In addition, in the blocks 42a, 42b, and 42c adjacent to the block 42d, a pixel disposed at the center of the block 42a is set as a center pixel 61a, a pixel disposed at the center of the block 42b is set as a center pixel 61b, and a pixel disposed at the center of the block 42c is set as a center pixel 61c.

The mixed tone curve 34 of the block 42a is set as G1[Y], the mixed tone curve 34 of the block 42b is set as G2[Y], the mixed tone curve 34 of the block 42c is set as G3[Y], the mixed tone curve 34 of the block 42d is set as G4[Y], and the mixed tone curve 34 of the target pixel 62d is set as Gc[Y]. The image processing unit 122 calculates Gc[Y] of the target pixel 62d through bilinear interpolation based on G1[Y], G2[Y], G3[Y], and G4[Y] of the blocks 42a to 42d. Then, the image processing unit 122 calculates the gain value of the target pixel 62d based on the pixel value and Gc[Y] of the target pixel 62d. It should be noted that the calculation method of the gain value of the target pixel 62d based on the bilinear interpolation is not limited to this. For example, the image processing unit 122 may calculate the gain values of the center pixels 61a, 61b, 61c, and 61d based on the pixel values and G1[Y], G2[Y], G3[Y], and G4[Y] of the center pixels 61a, 61b, 61c, and 61d and may calculate the gain value of the target pixel 62d through bilinear interpolation based on the gain values of the center pixels 61a, 61b, 61c, and 61d.

In the present example, the target pixel 62d on the block 42d is shown as the gain calculation of the pixel, but the gain value is also calculated in the same manner for each pixel of each block in the brightness image 41. The gain values of the center pixels 61a, 61b, 61c, and 61d, which are the center pixels in each block, are the gain values calculated based on G1[Y], G2[Y], G3[Y], and G4[Y], respectively.

As described above, the information processing device (image processing unit 122) of the embodiment selects the bright portion tone curve and the dark portion tone curve based on the amount of increase in exposure and the mode of the gradation processing and calculates the tone curve mixing rate with respect to the representative brightness value of each block, generates the mixed tone curve of each block based on the bright portion tone curve and the dark portion tone curve, and the tone curve mixing rate thereof, and determines the gain value to be applied to the target pixel 62d based on the mixed tone curve of the block 42d including the target pixel 62d, and each of the mixed tone curves of the blocks 42a, 42b, and 42c adjacent to the block 42d.

With this configuration, it is possible to achieve a feature of the local tone curve mapping of applying contrast with a tone curve having a desired taste or a smooth tone curve for each block. As a result, it is possible to maintain image contrast even in a case of imaging a scene having a difference between bright and dark by using a wide dynamic range. Therefore, it is possible to improve image quality.

### First Modification Process by Image Processing Unit 122

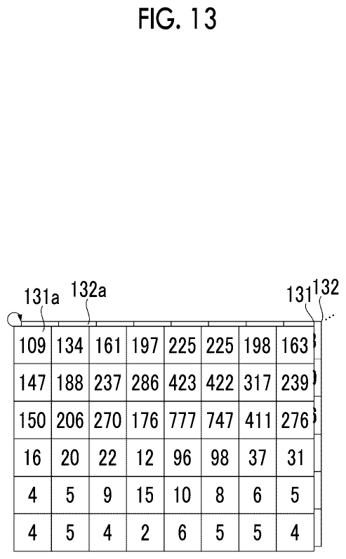

A first modification process by the image processing unit 122 will be described with reference to FIG. 13. FIG. 13 is a diagram showing an example of the representative brightness value for each block of a plurality of frames in the moving image data.

In a case where the data of the input image is moving image data, the image processing unit 122 generates the mixed tone curve 34 for each block in the target frame of the moving image data based on the mixed tone curve 34 for each block in a frame preceding the target frame. The moving image data is image data during video capturing. In addition, the moving image data may be image data for a live preview image (live view) during still image capturing. The preceding frame is a temporally preceding frame. The generation based on the mixed tone curve 34 for each block in the preceding frame means smoothing the mixed tone curve between the frames.

For example, as shown in FIG. 13, it is assumed that the representative brightness value of each block for generating the mixed tone curve 34 is calculated for a first frame 131, a second frame 132, . . . of the moving image. In this case, the image processing unit 122 corrects the representative brightness value of a first block 132a in the second frame 132 by weighted averaging with the representative brightness value of a first block 131a in the first frame 131. Similarly, the image processing unit 122 corrects the representative brightness value of each block in the second frame 132 by weighted averaging with the representative brightness value of each block in the first frame 131. The image processing unit 122 generates the mixed tone curve 34 for each block of the second frame 132 based on the representative brightness value of each block of the second frame 132 calculated by the correction.

In the moving image or the live preview image, in a case where, for example, an angle of view changes between preceding and subsequent frames, abrupt changes in tone curve for each block may occur and result in a deterioration in quality. In this case, by smoothing the tone curve of each block between frames, it is possible to suppress abrupt changes in tone curve and prevent a deterioration in quality. In the present example, the weighted averaging of the representative brightness values is performed based on two frames, but the present disclosure is not limited to this, and the weighted averaging of the representative brightness values may be performed over, for example, three or more frames.

### Second Modification Process by Image Processing Unit 122

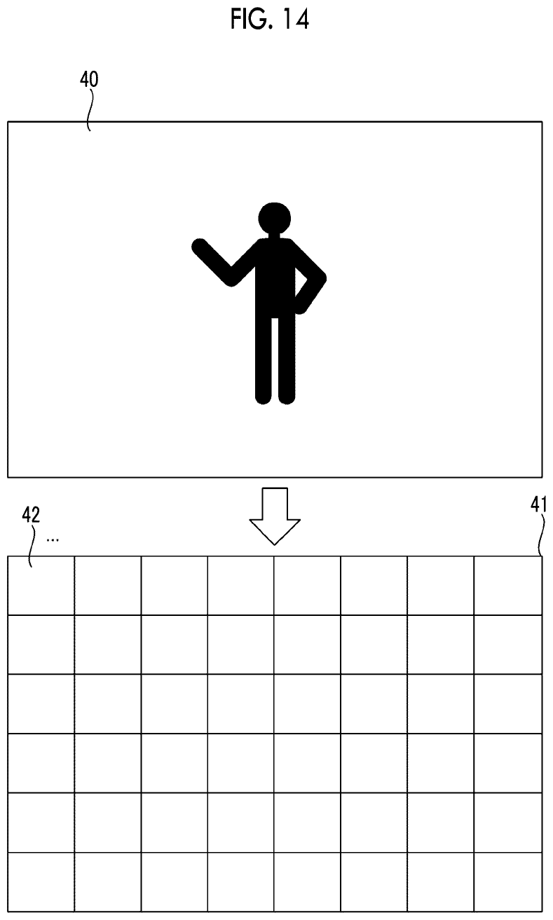

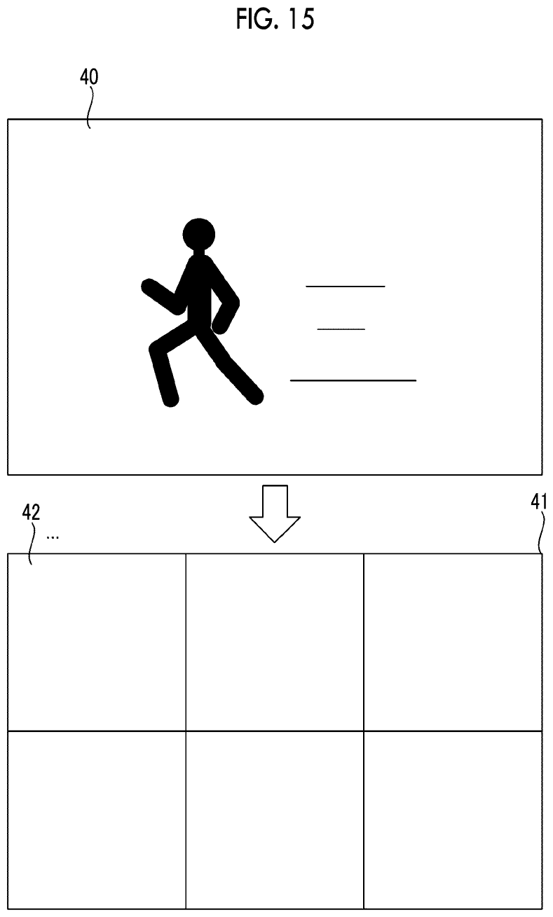

A second modification process by the image processing unit 122 will be described with reference to FIGS. 14 and 15. FIG. 14 is a diagram showing an example of the block 42 for dividing a still image. FIG. 15 is a diagram showing an example of the block 42 for dividing a video.

The image processing unit 122 determines the number of divisions of the block 42 for dividing the brightness image 41 according to the type of the image data to be input. The image processing unit 122 reduces, for example, in a case where the image data is moving image data, the number of divisions more than in a case where the image data is still image data. Specifically, as shown in FIG. 14, in a case where the data of an input image 40 is the still image data, the image processing unit 122 divides the brightness image 41 into, for example, blocks 42 of 6 vertically×8 horizontally. Meanwhile, as shown in FIG. 15, in a case where the data of the input image 40 is the moving image data, the image processing unit 122 divides the brightness image 41 into, for example, blocks 42 of 2 vertically×3 horizontally, which are the number of divisions fewer than that in a case of the still image data.

In the moving image or the live preview image, it is necessary to end the image processing in a shorter time than in the still image or the recorded image. Therefore, in a case of the moving image or the live preview image, the processing time of the image can be shortened by reducing the number of blocks for dividing the brightness image 41.

### Third Modification Process by Image Processing Unit 122

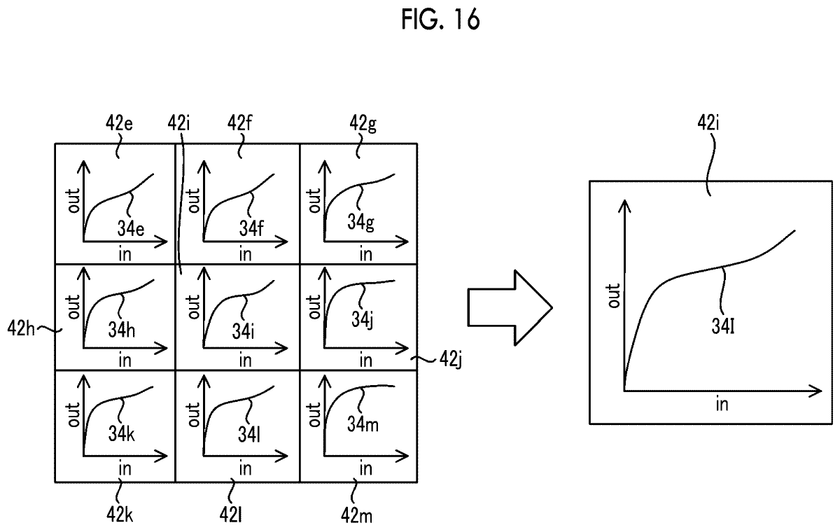

A third modification process by the image processing unit 122 will be described with reference to FIG. 16. FIG. 16 is a diagram showing an example of the correction of the mixed tone curve 34.

The image processing unit 122 corrects the mixed tone curve 34 of the target block by weighted averaging with the mixed tone curve 34 of the block different from the target block. For example, as shown in FIG. 16, it is assumed that a part of the region of the brightness image 41 is divided into blocks 42e to 42m, and the mixed tone curves of the blocks 42e to 42m are calculated as mixed tone curves 34e to 34m. In this case, the image processing unit 122 corrects the mixed tone curve 34i of the block 42i to the mixed tone curve 34I obtained by weighted averaging the mixed tone curve 34i and eight mixed tone curves 34e to 34h and 34j to 34m surrounding the mixed tone curve 34i. Specifically, in a case of correcting the mixed tone curve 34i, the image processing unit 122 calculates the mixed tone curve 34I by correcting the mixed tone curve 34i by weighted averaging in which a weighting coefficient of the mixed tone curve 34i located at the center is increased and weighting coefficients of the eight mixed tone curves 34e to 34h and 34j to 34m surrounding the mixed tone curve 34i are decreased.

By weighted averaging the tone curve of each block and the tone curves of the peripheral blocks, for example, it is possible to suppress an artifact that occurs in a case where there are abrupt changes in the tone curves of the adjacent blocks.

### Fourth Modification Process by Image Processing Unit 122

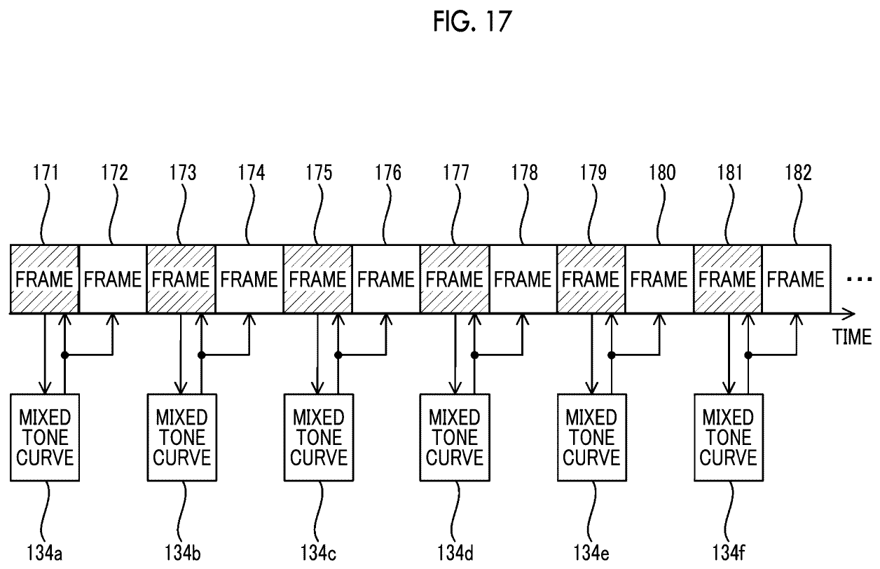

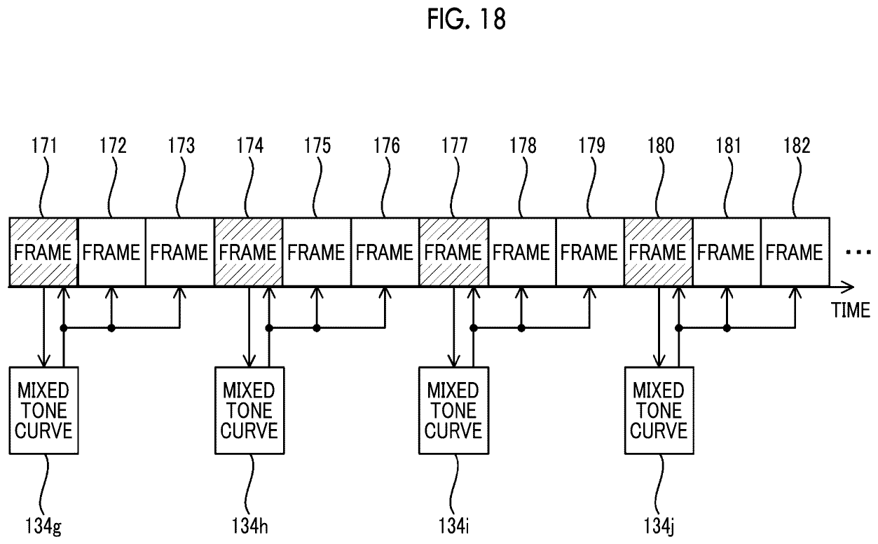

A fourth modification process by the image processing unit 122 will be described with reference to FIGS. 17 and 18. FIG. 17 is a diagram showing an example (first generation example) of the generation of the mixed tone curve 34 in a case where the image data is the moving image data. FIG. 18 is a diagram showing an example (second generation example) of the generation of the mixed tone curve 34 in a case where the image data is the moving image data.

In a case where the data of the input image is the moving image data, the image processing unit 122 generates the mixed tone curve 34 for each block for a periodic first target frame group in the moving image data and determines, based on the mixed tone curve 34 for each block generated for the first target frame group, the gain value of the mixed tone curve 34 for a second target frame group different from the first target frame group in the moving image data.

For example, as shown in FIG. 17, the image processing unit 122 sets, in a plurality of frames 171 to 182 . . . in the moving image, odd-numbered frames 171, 173, 175, . . . as the first target frame group and even-numbered frames 172, 174, 176, . . . as the second target frame group. It should be noted that it is assumed that the frame 171 is a temporally earliest frame.

In this case, the image processing unit 122 generates mixed tone curves 134a, 134b, 134c, . . . of the frames for the odd-numbered frames 171, 173, 175, . . . , and applies the generated mixed tone curves 134a, 134b, 134c, . . . as the mixed tone curves of the odd-numbered frames 171, 173, 175, . . . . Generating the mixed tone curves 134a, 134b, 134c, . . . of the frames is generating the mixed tone curve for each block of the frames. Then, the image processing unit 122 applies the mixed tone curves 134a, 134b, 134c, . . . respectively generated in the preceding odd-numbered frames 171, 173, 175, . . . , to the even-numbered frames 172, 174, 176, . . . as the mixed tone curves of the even-numbered frames 172, 174, 176, . . . . That is, the image processing unit 122 does not generate the mixed tone curves of the frames for the even-numbered frames 172, 174, 176, . . . .

In the present example, a case has been described in which the odd-numbered frames 171, 173, 175, . . . are set as the first target frame group, but the frames to be set as the first target frame group may be changed for each block of the frames, for example. That is, the block for generating the mixed tone curve may vary for each frame. For example, for the first block in each frame, odd-numbered frames may be set as the first target frame group, and for the second block, even-numbered frames may be set as the first target frame group.

In addition, for example, as shown in FIG. 18, the image processing unit 122 may set, in the plurality of frames 171 to 182 . . . in the moving image, the frames 171, 174, 177, 180, . . . as the first target frame group and the frames 172, 173, 175, 176, 178, 179, 181, 182, . . . as the second target frame group. That is, the image processing unit 122 may set the frames to be set as the first target frame group every three frames.

In this case, the image processing unit 122 generates mixed tone curves 134g, 134h, 134i, 134j, . . . of the frames for the frames 171, 174, 177, 180, . . . and applies the generated mixed tone curves 134g, 134h, 134i, 134j, . . . as the mixed tone curves of the frames 171, 174, 177, 180, . . . , respectively. Then, the image processing unit 122 applies the mixed tone curve 134g generated in the frame 171 to the frames 172 and 173 as the mixed tone curves of the frames 172 and 173 and applies the mixed tone curve 134h generated in the frame 174 to the frames 175 and 176 as the mixed tone curves of the frames 175 and 176. Similarly, the image processing unit 122 applies the mixed tone curve 134i generated in the frame 177 to the frames 178 and 179 and applies the mixed tone curve 134j generated in the frame 180 to the frames 181 and 182. That is, the image processing unit 122 generates the mixed tone curve at a rate of once for every three frames. The image processing unit 122 does not generate the mixed tone curves of the frames 172, 173, 175, 176, 178, 179, 181, 182, . . . .

In the present example, the frames to be set as the first target frame group are set every three frames, but the present disclosure is not limited to this, and the frame may be set, for example, every four or more frames. In addition, the point that the frames to be set as the first target frame group may be changed for each block is the same as a case described with reference to FIG. 17.

In addition, in a case where the data of the input image is the moving image data, the image processing unit 122 may set the first target frame group according to attribute information of the moving image data. The attribute information is an imaging frame rate, a recording format (for example, full high definition (FHD), 4K, or 8K), or the like.

For example, the image processing unit 122 may change a value of N to be set as the first target frame group in a rate of once for every N frames according to the imaging frame rate or the recording format. Specifically, the image processing unit 122 may reduce the number of frames for generating the mixed tone curve, by reducing the number of frames in the first target frame group as the imaging frame rate increases or the recording format has a larger data size.

The processing time can be shortened by thinning out frames for calculating the mixed tone curve in a case where the image data size is large or the imaging frame rate is high.

### Fifth Modification Process by Image Processing Unit 122

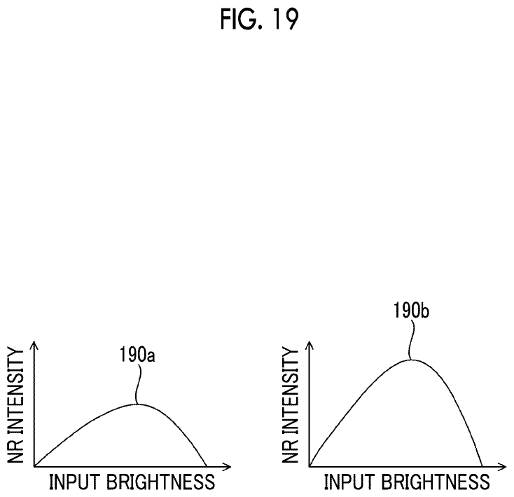

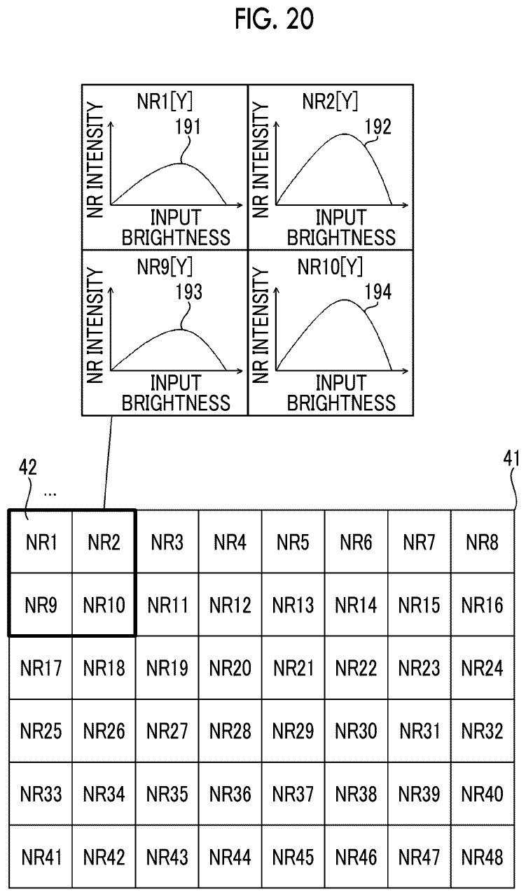

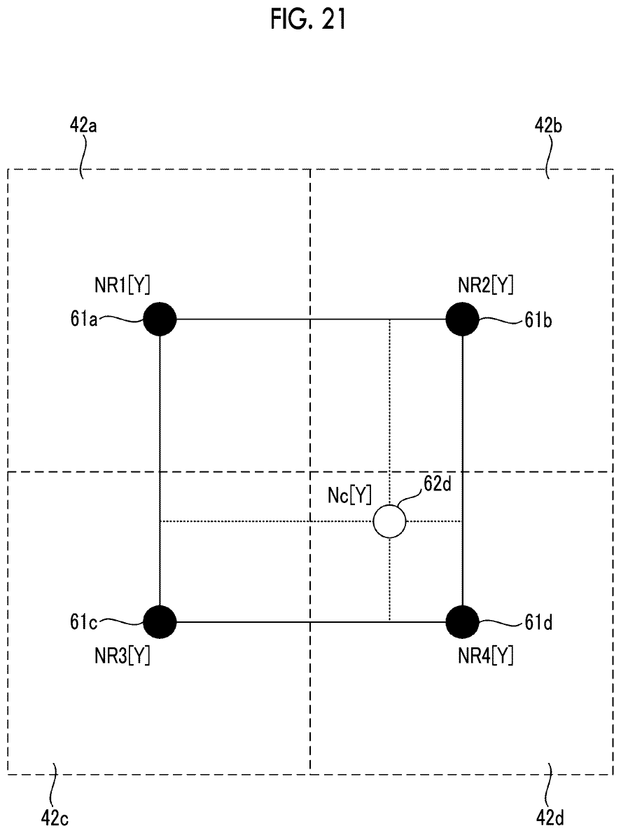

A fifth modification process by the image processing unit 122 will be described with reference to FIGS. 19 to 21. FIG. 19 is a diagram showing an example of the correspondence information between an input brightness and a noise reduction intensity. FIG. 20 is a diagram showing an example of the noise reduction intensity determined for each block 42. FIG. 21 is a diagram showing an example of the calculation of the noise reduction intensity of each pixel.

The image processing unit 122 determines the noise reduction intensity of each pixel based on the determined gain value of each pixel. In a case where the local tone curve mapping (LTM) process is performed, the gain value varies for each pixel of the block. Since noise becomes more noticeable as the gain value increases, an appropriate noise reduction intensity also varies for each pixel. Therefore, the image processing unit 122 determines, based on the determined gain value of each pixel, the noise reduction intensity for reducing the noise, for each pixel of the image data that has been subjected to a correction process using the gain value.

For example, as shown in FIG. 19, the image processing unit 122 generates correspondence information 190a and 190b, and the like between the pixel value and the noise reduction intensity for each block based on the representative brightness value of each block 42. The correspondence information between the pixel value and the noise reduction intensity is a function of the noise reduction intensity. For example, in a case where the representative brightness of the block 42 is bright, the required amount of increase (gain value) is small. Therefore, the noise reduction intensity required in the block 42 becomes weaker. In that case, for example, as shown in the correspondence information 190a, a function having a small noise reduction intensity with respect to the input brightness is used. On the other hand, in a case where the representative brightness of the block 42 is dark, the required amount of increase is large. Therefore, the noise reduction intensity required in the block 42 becomes stronger. In that case, for example, as shown in the correspondence information 190b, a function having a large noise reduction intensity with respect to the input brightness is used.

As shown in FIG. 20, the image processing unit 122 generates the correspondence information 191 to 194 and the like for each block 42 divided into a grid-like shape of, for example, 6 vertically×8 horizontally, and determines the noise reduction intensity for each block 42.

Then, the image processing unit 122 calculates, for each pixel of the block 42, the noise reduction intensity to be applied to the target pixel based on the correspondence information of the target block including the target pixel and the correspondence information of the block different from the target block. For example, a case is considered in which the noise reduction intensity of the target pixel 62d on the block 42d is calculated in the blocks 42a, 42b, 42c, and 42d of the brightness image 41 divided as shown in FIG. 21.

In this case, the image processing unit 122 sets the pixel disposed at the center of the block 42d including the target pixel 62d as the center pixel 61d. In addition, the image processing unit 122 sets, in the blocks 42a, 42b, and 42c adjacent to the block 42d, the pixel disposed at the center of the block 42a as the center pixel 61a, the pixel disposed at the center of the block 42b as the center pixel 61b, and the pixel disposed at the center of the block 42c as the center pixel 61c.

The correspondence information between the pixel value and the noise reduction intensity in the block 42a is set as NR1[Y], the correspondence information between the pixel value and the noise reduction intensity in the block 42b is set as NR2[Y], the correspondence information between the pixel value and the noise reduction intensity in the block 42c is set as NR3[Y], the correspondence information between the pixel value and the noise reduction intensity in the block 42d is set as NR4[Y], and the correspondence information between the pixel value and the noise reduction intensity in the target pixel 62d is set as Nc[Y]. The image processing unit 122 calculates Nc[Y] of the target pixel 62d through bilinear interpolation based on NR1[Y], NR2[Y], NR3[Y], and NR4[Y] of the blocks 42a to 42d. Then, the image processing unit 122 calculates the noise reduction intensity of the target pixel 62d based on the pixel value and Nc[Y] of the target pixel 62d. The calculation method of the noise reduction intensity of the target pixel 62d based on the bilinear interpolation is not limited to this. For example, the image processing unit 122 may calculate the noise reduction intensity of the target pixel 62d through bilinear interpolation based on the noise reduction intensities of the center pixels 61a, 61b, 61c, and 61d by calculating the noise reduction intensities of the center pixels 61a, 61b, 61c, and 61d based on the pixel values and NR1[Y], NR2[Y], NR3[Y], and NR4[Y] of the center pixels 61a, 61b, 61c, and 61d.

In the present example, the target pixel 62d on the block 42d is shown as the calculation of the noise reduction intensity of the pixel, but the noise reduction intensity is also calculated in the same manner for each pixel of each block in the brightness image 41. The noise reduction intensity of the center pixel in each block is the noise reduction intensities calculated based on NR1[Y], NR2[Y], NR3[Y], and NR4[Y], respectively.

In the normal imaging, since the gain value does not change for each region of a screen, a uniform noise reduction intensity is used in the screen. On the other hand, in the local tone curve mapping, since the gain value varies for each pixel, it is necessary to determine the noise reduction intensity according to the gain value. Therefore, by calculating the noise reduction intensity for each pixel of each block as in the present example, the noise can be appropriately reduced.

### Sixth Modification Process by Image Processing Unit 122

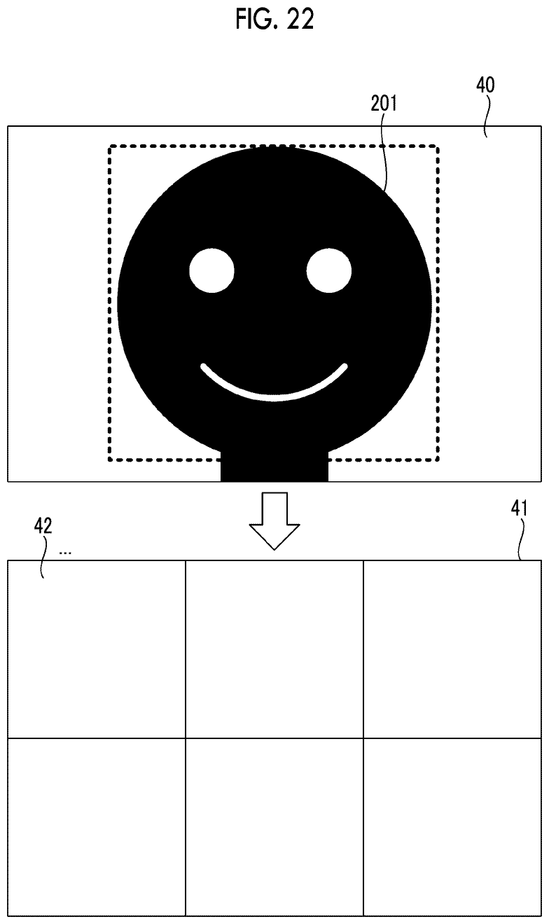

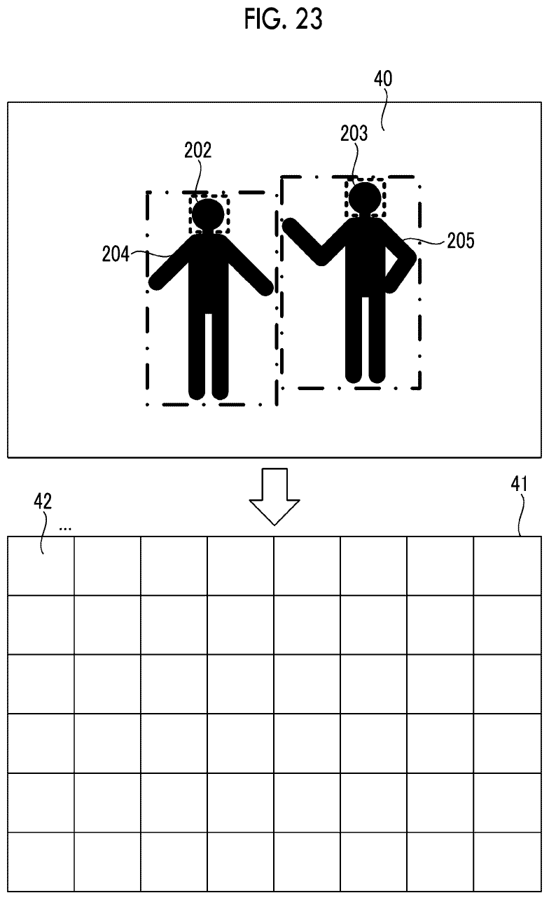

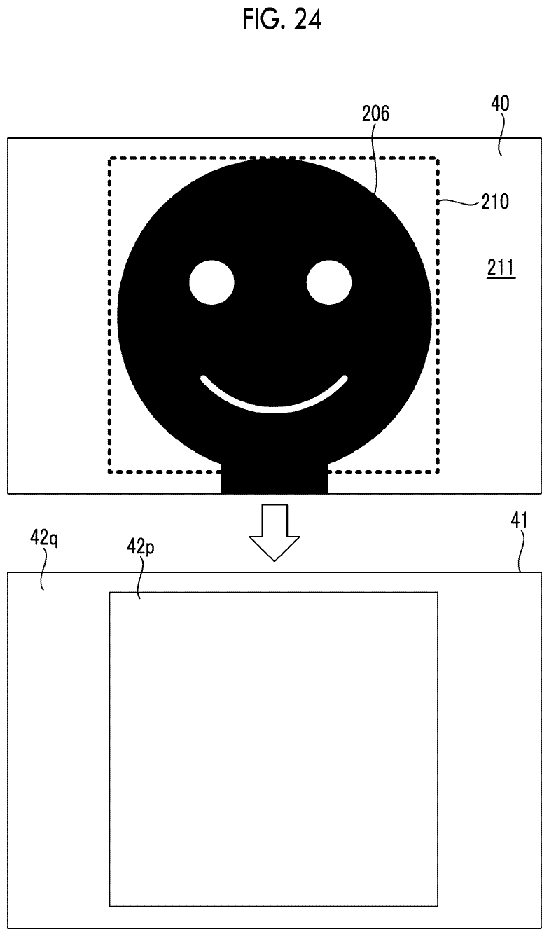

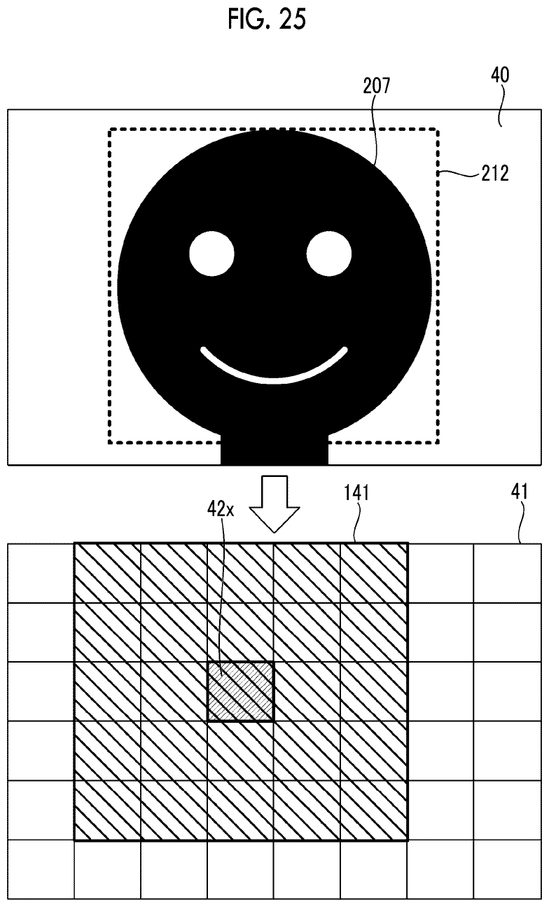

A sixth modification process by the image processing unit 122 will be described with reference to FIGS. 22 to 24. FIG. 22 is a diagram showing an example of the image division in a case where the subject is large. FIG. 23 is a diagram showing an example of the image division in a case where the subject is small. FIG. 24 is a diagram showing an example of the image division for each type of the subject.

The image processing unit 122 determines the number of divisions of the block 42 for dividing the brightness image 41 based on a result of subject detection of the image data.

For example, in the result of the subject detection in the input image 40 as shown in FIG. 22, in a case where it is determined that the size of a subject 201 is large, the image processing unit 122 reduces the number of divisions of the brightness image 41. In the present example, the brightness image 41 is divided into blocks 42 of 2 vertically×3 horizontally. Specifically, in a case where a face of a person is largely captured in an up-close manner, it is not desirable that a dark region (for example, pupils, eyebrows, lips, and the like) is brightened and a bright region (for example, sclera, tooth, and the like) is darkened by local tone curve mapping (LTM). Therefore, the number of divisions is reduced to increase the size of each block 42, so that fine parts of the face are prevented from being determined as the bright region or the dark region.

On the other hand, for example, in the result of the subject detection in the input image 40 as shown in FIG. 23, in a case where it is determined that the sizes of faces 202 and 203 (subject) of the persons are small, the image processing unit 122 increases the number of divisions of the brightness image 41 more than the number of divisions in a case where it is determined that the size of the subject is large. In the present example, the brightness image 41 is divided into blocks 42 of 6 vertically×8 horizontally.

In the example of the input image 40 shown in FIG. 23, it is also possible to detect both the faces 202 and 203 of the persons and entire persons 204 and 205 as the subjects. Therefore, in this case, the image processing unit 122 may determine the number of divisions based on the detection result of the faces 202 and 203 of the persons or may determine the number of divisions based on the detection result of the entire persons 204 and 205. In addition, the image processing unit 122 may determine the number of divisions by comprehensively judging the detection results of both the faces 202 and 203 of the persons and the entire persons 204 and 205. Further, for example, in a case where the detected subject in the result of the subject detection in the input image 40 is a “landscape”, the image processing unit 122 may increase the number of divisions more than in a case where the detected subject is a person.

In addition, the image processing unit 122 may determine the division shape of the block 42 for dividing the brightness image 41 based on the result of the subject detection of the image data.

For example, in the result of the subject detection in the input image 40 as shown in FIG. 24, in a case where a subject 206 (in the present example, the face of the person) is detected, the image processing unit 122 divides a detected region 210 of the subject 206 and the other region 211 into a rectangular block 42p and a block 42q having a shape excluding the block 42p. The shape of the block 42p divided as the detected region 210 of the subject 206 is not limited to the rectangular shape and may be, for example, a shape along the shape of the face of the person who is the subject.

Since the desired effect of the local tone curve mapping varies depending on the size or the type of the subject, it is preferable to adjust the size of the block by changing the number of divisions according to the subject as in the present example.

### Seventh Modification Process by Image Processing Unit 122

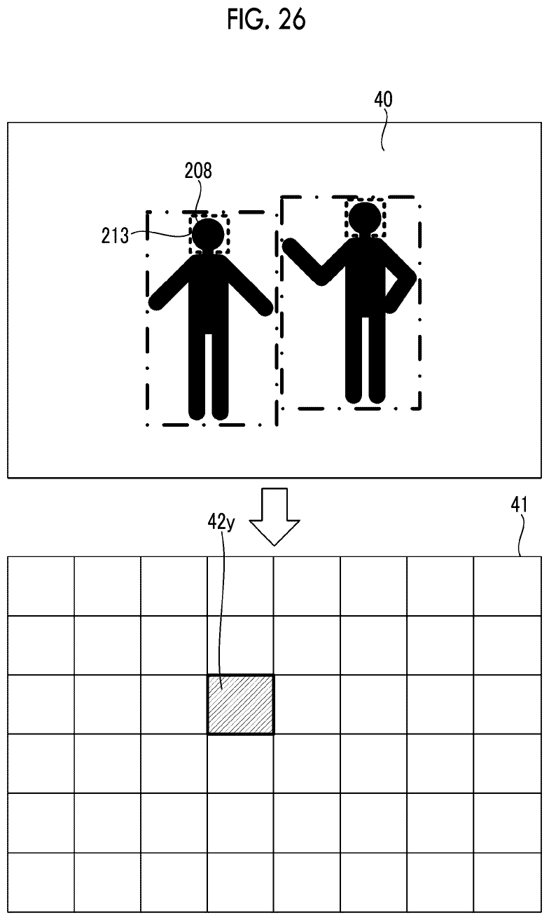

A seventh modification process by the image processing unit 122 will be described with reference to FIGS. 25 and 26. FIG. 25 is a diagram showing an example of weighting with the peripheral block in a case where the detected subject is large. FIG. 26 is a diagram showing an example of the subject for which the weighting with the peripheral block is not performed.

The image processing unit 122 may determine, based on the result of the subject detection of the image data, the gain value of the mixed tone curve based on the mixed tone curve of the target block and the mixed tone curve of the block different from the target block.

For example, in the result of the subject detection in the input image 40 as shown in FIG. 25, in a case where the size of a detected subject 207 is large, the image processing unit 122 expands a range of the peripheral blocks for which the weighted averaging is performed, in determining the gain value of the mixed tone curve of the target block including a part of the region of the subject 207. Specifically, in a case where the brightness image 41 is divided into blocks of 6 vertically×8 horizontally, and the gain value of the mixed tone curve of a target block 42x including a part of the region of the subject 207 is determined, the image processing unit 122 may determine the gain value by weighted averaging the mixed tone curve of the target block 42x and the mixed tone curves of the peripheral blocks (the blocks within a diagonal line region) of 5 vertically×5 horizontally that surround the target block 42x. A range 141 indicated by the peripheral blocks of 5 vertically×5 horizontally is a range corresponding to a detected region 212 of the subject 207 in the input image 40.

In addition, the image processing unit 122 may determine, in a case of determining the gain of the target block by performing weighting, the gain value by increasing the weight coefficients of the peripheral blocks as the size of the subject is larger, that is, the number of blocks included in the range 141 indicated by the peripheral blocks is larger.

In addition, for example, in the result of the subject detection in the input image 40 as shown in FIG. 26, in a case where the size of a detected subject 208 is small, the image processing unit 122 does not perform the weighted averaging in determining the gain value of the mixed tone curve of the target block corresponding to the region of the subject 208. Specifically, in a case where the size of a detected region 213 of the subject 208 and the size of a target block 42y corresponding to the detected region 213 are substantially the same size in the brightness image 41 divided into blocks of 6 vertically×8 horizontally, the image processing unit 122 does not perform the correction process by the weighting with the mixed tone curve of the peripheral block in determining the gain value of the mixed tone curve of the target block 42y.

In a case of a configuration (operation circuit) in which the number of divisions of the block cannot be changed according to the size of the subject or the like, by determining the gain value of the target block by weighted averaging with the peripheral blocks, an appropriate effect of the local tone curve mapping can be obtained.

The information processing method described in the embodiment described above can be implemented by executing a control program prepared in advance on a computer. This information processing program is recorded on a computer-readable storage medium and executed by being read from the storage medium. In addition, this information processing program may be provided in a form of being stored in a non-transitory storage medium, such as a flash memory, or may be provided via a network, such as the Internet. The computer that executes this information processing program may be included in the information processing device, may be included in an electronic device such as a smartphone, a tablet terminal, or a personal computer that is capable of communicating with the information processing device, or may be included in a server device that is capable of communicating with these information processing device and electronic device.

### EXPLANATION OF REFERENCES

21: bright-dark tone curve selection unit
22: brightness conversion unit
23: representative brightness value calculation unit
24: tone curve mixing rate calculation unit
25: tone curve mixing unit
26: bilinear interpolation unit
27: gain multiplication unit
31: bright portion tone curve
31a, 32a: input value difference
31b, 32b: output value difference
32: dark portion tone curve
33: reference tone curve
34, 34e to 34m, 34I, 134a to 134j: mixed tone curve
40: input image
41: brightness image
42, 42a to 42d, 42e to 42m, 42p, 42q: block
42x, 42y: target block
51, 190a, 190b, 191 to 194: correspondence information
61a to 61d: center pixel
62d: target pixel
100: imaging apparatus
110: lens device
120: main body
121: imaging element
122: image processing unit
131: first frame
131a, 132a: first block
132: second frame
141: range
171 to 182: frame
201, 206 to 208: subject
202, 203: face
204, 205: entire person
210, 212, 213: detected region
211: region

What is claimed is:

1. An information processing device that performs processing on image data to be input, the information processing device comprising:
a processor configured to:
acquire a first tone curve and a second tone curve;
divide the image data into a plurality of blocks and determine a representative value for each block;
generate a third tone curve for each block based on the first tone curve, the second tone curve, and the representative value; and
determine a correction value to be applied to a target pixel based on the third tone curve of a target block including the target pixel and the third tone curve of a block different from the target block.

2. The information processing device according to claim 1,
wherein the processor is configured to generate the third tone curve by mixing the first tone curve and the second tone curve at a mixing ratio based on the representative value.

3. The information processing device according to claim 2,
wherein the processor is configured to determine the mixing ratio corresponding to the representative value based on a mode of the processing.

4. The information processing device according to claim 1,
wherein an average value of output values of the first tone curve is higher than an average value of output values of the second tone curve.

5. The information processing device according to claim 4,
wherein the output values of the first tone curve are equal to or greater than the output values of the second tone curve for all input values.

6. The information processing device according to claim 1,
wherein the processor is configured to acquire the first tone curve and the second tone curve that correspond to a mode of the processing.

7. The information processing device according to claim 1,
wherein the processor is configured to, in a case where the image data is moving image data, generate the third tone curve of a target frame of the moving image data based on the third tone curve of a frame preceding the target frame.

8. The information processing device according to claim 1,
wherein the processor is configured to determine the number of divisions of the block according to a type of the image data to be input.

9. The information processing device according to claim 1,
wherein the processor is configured to correct the third tone curve of the target block by weighted averaging with the third tone curve of a block different from the target block.

10. The information processing device according to claim 1,
wherein the processor is configured to, in a case where the image data is moving image data:
generate the third tone curve for a periodic first target frame group in the moving image data; and
determine, based on the third tone curve generated for the first target frame group, the correction value for a second target frame group different from the first target frame group in the moving image data.

11. The information processing device according to claim 10,
wherein the processor is configured to set the first target frame group according to attribute information of the moving image data.

12. The information processing device according to claim 1,
wherein the processor is configured to determine, based on the determined correction value of each pixel, a noise reduction intensity with respect to each pixel of the image data that has been subjected to a correction process using the correction value.

13. The information processing device according to claim 1,
wherein the processor is configured to:
generate correspondence information between a pixel value and a noise reduction intensity for each block based on the representative value; and
determine a noise reduction intensity to be applied to the target pixel based on the correspondence information of the target block including the target pixel and the correspondence information of the block different from the target block.

14. The information processing device according to claim 1,
wherein the processor is configured to determine at least any of the number of divisions of the block or a division shape of the block based on a result of subject detection of the image data.

15. The information processing device according to claim 1,
wherein the processor is configured to determine, based on a result of subject detection of the image data, the correction value based on the third tone curve of the target block and the third tone curve of a block different from the target block.

16. An information processing method executed by an information processing device that includes a processor and performs processing on image data to be input, the information processing method comprising:
acquiring a first tone curve and a second tone curve;
dividing the image data into a plurality of blocks and determining a representative value for each block;
generating a third tone curve for each block based on the first tone curve, the second tone curve, and the representative value; and
determining a correction value to be applied to a target pixel based on the third tone curve of a target block including the target pixel and the third tone curve of a block different from the target block.

17. A non-transitory computer-readable medium storing an information processing program for an information processing device that includes a processor and performs processing on image data to be input, the information processing program causing the processor to execute a process comprising:
acquiring a first tone curve and a second tone curve;
dividing the image data into a plurality of blocks and determining a representative value for each block;
generating a third tone curve for each block based on the first tone curve, the second tone curve, and the representative value; and
determining a correction value to be applied to a target pixel based on the third tone curve of a target block including the target pixel and the third tone curve of a block different from the target block.
